(19) United States
(12) Patent Application Publication
(10) Pub. No.: US 2014/0347963 A1
(43) Pub. Date: Nov. 27, 2014

(54) Reversible Mystery Watch

(71) Applicant: Ali & Co Genèva SA, Genèva (CH)

(72) Inventors: Ali El Alej, Châtelaine (CH); Gilles Rey-Mermet, Sion (CH)

(21) Appl. No.: 14/365,394

(22) PCT Filed: Dec. 17, 2012
(86) PCT No.: PCT/EP2012/075864

§ 371 Date: Jun. 13, 2014

(30) Foreign Application Priority Data
Dec. 16, 2011 (CH) 1989/2011

(51) Int. Cl. G04B 45/04; G04D 3/00; A44C 5/18; G04G 17/04; G04C 15/00; G04B 19/24; G04G 9/00

(52) U.S. Cl. CPC G04B 45/046; G04B 19/24; G04D 3/0092; G04G 9/0064; G04G 17/045; G04C 15/0054; A44C 5/185
USPC 368/29; 368/160

(57) ABSTRACT

A watch including: a case middle forming a transparent central region, a first and second display placed on each face of the watch; at least two transparent indicator plates placed in a pivoting fashion in the central region and including at least one indicator; a drive unit driving each indicator plate in rotation at its periphery; a holding element capable of holding each indicator plate at its periphery in a position roughly perpendicular to its rotation axis; the drive unit and holding element being housed completely in the case middle of the watch such that the drive unit and the holding element the are outside the central region; and said at least one indicator of each of the indicator plates is visible on one face so as to form the first display, and visible on the other face so as to form the second display.

### FIELD OF THE INVENTION

The present invention relates to the field of watchmaking and more particularly to so-called mystery watches.

### STATE OF THE ART

So-called mystery watches are “transparent” watches in which the movement is either concealed in the frame of the watchcase or held between several transparent sapphires, often overlaid with a non-reflecting and/or metallized coating, so as to give it the appearance of floating in the case middle. The absence of visible movement and the floating hands impart to these watches a magical aspect.

Clocks or pendulum clocks in whose base the movement is generally located have been known since the 19^{th} century. In another type of construction, so-called mystery watches have transparent crystal or sapphire discs on which the hands are attached. The rim of the discs is provided with teeth that enable the discs and thus the hands to be driven in rotation by means of pinions concealed in the frame of the watchcase. An example of such a device is described in patent CH639812.

Document EP0673519 discloses a transparent watch provided with a seconds' hand, a minutes' hand and an hours' hand, whose movement is distributed by means of transparent discs driven by one or several motors confined in the case middle of the watch. A transparent toothed wheel drives the hollow shaft of each hand, wherein the drive unit (common or specific to each hand) is mounted invisibly in the ring of the case.

Document GB2351163 describes a watch comprising transparent discs on which the hands are inscribed. The rim of the discs is provided with teeth that enable the discs and thus the hands to be driven in rotation by means of pinions placed in the frame of the watchcase. The pinions are themselves driven by a drive mechanism placed in the case bottom of the watch.

In the solutions presented hereabove, the discs are mounted on shafts placed in the middle of the watch's dial. On the other hand, the arrangement of the discs and of the drive mechanism does allows the time to be read on one face of the watch only. In the case where the drive mechanism is placed in the frame of the watchcase, the latter is often very thick.

### BRIEF SUMMARY OF THE INVENTION

One aim of the present invention is to propose a mystery watch free from the limitation of the known prior art.

According to the invention, this aim is achieved notably by means of a watch having: a watchcase comprising a case middle forming a transparent central region, a first display placed on the side of a first face and a second display placed on the side of a second face opposite the first face; at least two transparent indicator plates placed in a pivoting fashion and superimposed in the central region, wherein at least each indicator plate comprises at least one indicator; a drive unit, housed completely in the case middle and driving each indicator plate in rotation at its periphery; holding means, housed completely in the watch's case middle and capable of holding each indicator plate at its periphery in a position roughly perpendicular to its rotation axis; such that the drive unit and the holding means are outside the central region and that said at least one indicator of each of the indicator plates is visible on the first face so as to form the first display, and visible on the second face so as to form the second display.

In another embodiment, each indicator plate can be held at its periphery by means of rollers comprised in the case middle.

In another embodiment, each indicator plate can have the shape of a disc comprising a peripheral toothing; wherein the toothing meshes with the drive unit so as to drive the indicator plate.

In yet another embodiment, the toothing can be formed integrally with each indicator plate.

In yet another embodiment, the indicator plate can comprise an optically variable element.

In yet another embodiment, said at least two transparent indicator plates can comprise an hours' indicator plate and a minutes' indicator plate.

In yet another embodiment, said at least two transparent indicator plates can furthermore comprise an indicator plate for displaying the seconds and/or an indicator plate for displaying the dates and/or an indicator plate for displaying the power reserve.

In yet another embodiment, the first display and the second display can comprise markings.

In yet another embodiment, the markings can be comprised on an element of the first and/or of the second display, wherein the element is close to the periphery of the central region.

In yet another embodiment, the indicators can be executed with the plate in a same injection mold; or yet again, the indicators can be executed by over-molding during the plastic injection of the plate, making it possible to manufacture the plate and the indicator of different materials.

In yet another embodiment, the watch can further have a bracelet and two fastening elements for attaching the bracelet onto the case middle so that the watch can be worn on a wrist; wherein each of the fastening elements comprises, at one extremity, first affixing means for attaching the fastening element in a pivoting fashion onto the case middle and, at the other extremity, second affixing means for attaching the bracelet in a pivoting fashion onto the fastening element; such that the case middle and the bracelet adjust to the wrist when the watch is worn.

In yet another embodiment, the drive unit can include a stepping motor of the Lavet type; wherein the motor can comprise a stator having roughly the shape of an arc of circle and a rotor comprised at one extremity of the stator, in the extension of the arc formed by the stator.

One advantage of the proposed mystery watch relative to the prior art is that it is reversible, i.e. it allows the display on the two faces to be read. Another advantage of the watch is that it makes it possible to create a visual interest that differs depending on the face of the watch that is viewed. The configuration of the watch also enables a greater transparent surface than that of known mystery watches.

### BRIEF DESCRIPTION OF THE FIGURES

Examples of embodiments of the invention are indicated in the description illustrated by the attached figures in which:

FIG. 1 illustrates an arrangement of a mystery watch, according to one embodiment;

FIG. 2 represents a detail of the mystery watch, according to one embodiment;

FIG. 3 shows the watch comprising a bracelet and two fastening elements, according to one embodiment; and

FIG. 4 illustrates a stepping motor, according to one embodiment.

### EXAMPLE(S) OF WAYS FOR EXECUTING THE INVENTION

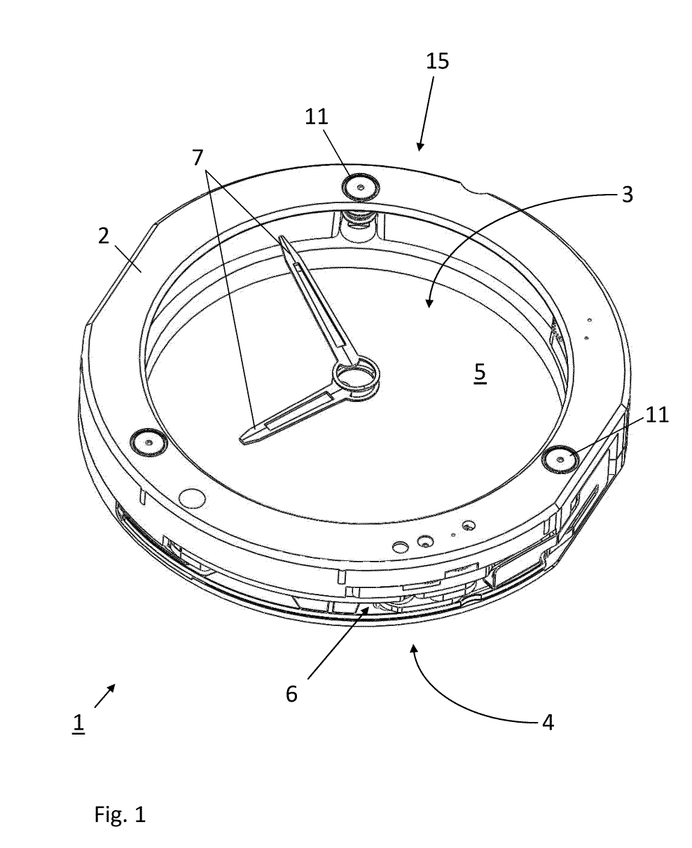

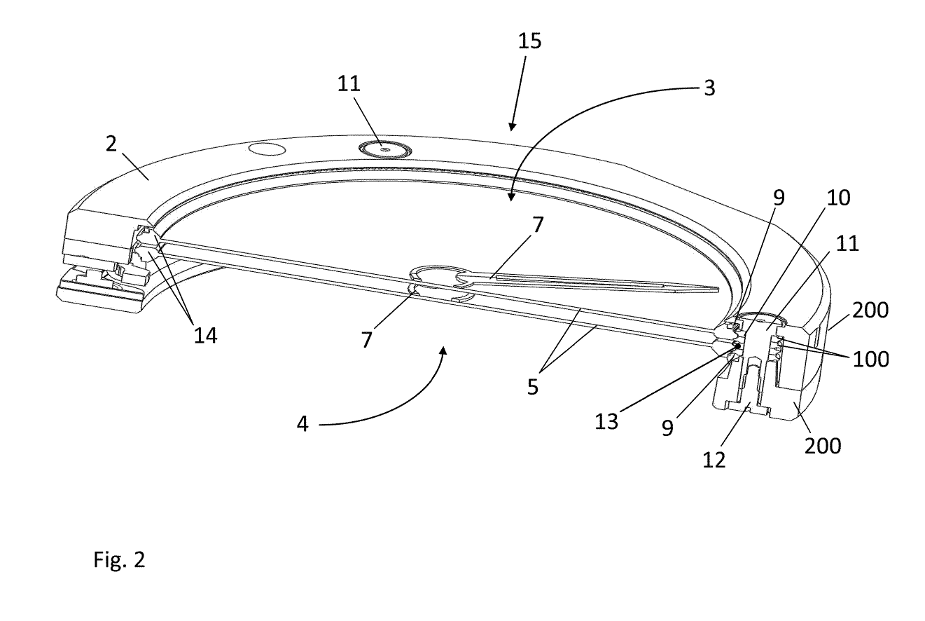

FIGS. 1 and 2 illustrate the arrangement of a watch according to one embodiment of the invention. The watchcase 1 is composed of a case middle 2 having an essentially annular shape, wherein the inner diameter of the case middle 2 delimits a central region indicated by reference number 15 in FIG. 1. Here, the central region 15 is concentric, with the case middle 2 being ring-shaped. The watchcase 1 can be closed on a first face 3 by a transparent element (not represented), for example an anti-scratch glass. The second face 4 can also be closed by a transparent element (also not represented). A drive unit 6 is housed invisibly in the case middle 2. In other words, the drive unit 6 is housed completely in the case middle 2 of the watch 1 outside of the central region 15. In one embodiment, not represented, the case of the watch 1 can also comprise a flange, joints and a means for opening one of the faces 3, 4 of the watch 1 to mount and/or maintain the movement, and/or a partial opening for only changing the battery (see here below).

In one embodiment, the watch 1 comprises at least two transparent indicator plates 5 mounted in pivoting fashion and superimposed in the central region 15 of the watch 1. Each of the indicator plates 5 can comprise at least one indicator 7. In the example of FIGS. 1 and 2, the watch 1 is represented with an indicator plate of the hours and an indicate plate 5 of the minutes. Each of the indicator plates 5 has the shape of a disc comprising a peripheral toothing 9. The toothing 9 can take the shape of an annular toothing placed at the periphery 14 of the indicator plate 5 or can be formed integrally with the indicator plate 5. The peripheral toothing 9 is arranged so as to mesh with the drive unit 6, so as to drive in rotation the indicator plate 5. For example, the indicator plate 5 of the hours can be driven with the hours' wheel, and the indicator plate 5 of the minutes can be driven with the minutes' wheel. In this manner, the indicator 7 of the hours and of the minutes are driven as would be the hours' resp. minutes' hands in a conventional watch display. Other drive means of the indicator plate 5 are also possible. For example, the indicator plate 5 can have a smooth periphery 14 enabling friction drive.

In FIGS. 1 and 2, each of the indicator plates 5 is formed of a transparent material and comprises each an indicator 7 having the shape of a hand. The indicator or indicators 7 can of course have any other shape than that of a hand. The indicators 7 can be printed, engraved, transferred or painted onto the plate 5. The indicators 7 can also be in the shape of a structure applied onto the plate 5 or even be included in the form of a selective modification of the transparent material of the indicator plate 5. In one variant embodiment, the indicator plate or plates 5 and the indicator or indicators 7 are formed by stamping or engraving. In another variant embodiment, the indicators 7 are executed with the plate 5 by means of a form made in the injection mold of the plate 5, in the case where the plate and the indicator 7 are manufactured of the same material. The indicators 7 can also be formed by over-molding during the plastic injection of the plate 5, making it thus possible to manufacture the plate 5 and the indicator 7 of different materials (for example, the plate being transparent and the indicator being opaque).

In another variant embodiment, the indicator plates 5 have a roughly identical shape in order to simplify the manufacturing process as well as the assembly process of the watch 1.

In one embodiment, the indicator plates 5 are held at their periphery by holding means 10, housed completely in the case middle 2 of the watch 1 outside the central region 15. The holding means 10 enable the indicator plates 5 to be held in a position roughly perpendicular to their axis of rotation, without any other holding means. In the example of FIGS. 1 and 2, the indicator plates 5 are held in rotation by means of rollers 10 fastened in pivoting fashion in the case middle 2. More particularly, each indicator plate 5 is mounted in rotation by means of three rollers 10 spaced angularly from one another by approx. 120°. Other arrangements for the rollers 10 are also possible inasmuch as the arrangement provides good guiding to the indicator plates 5. For example, the spacing between the rollers 10 can be different from 120° and/or the indicator plate 5 can be guided in rotation by two or more than three rollers 10.

FIG. 2 shows a cross section of the case middle 2 illustrating a detail of a roller 10. In this example, the roller 10 is formed of two parts 100 superimposed one on another and turning freely around a stud 11 integrally united with the case middle 2. The two superimposed parts 100 form a groove 13 of a shape complementary to that of the periphery 14 of the indicator plate 5. In this configuration, the indicator plate 5 lodges in the groove 13, thus making the guiding of the indicator plate 5 easier. Other arrangements of the rollers are also possible. For example, the rollers 10 can comprise a ball bearing. Still in the example of FIG. 2, the stud 11 is screwed in a clamping screw 12 that also serves to fasten two portions 200 of the case middle 2.

In the configuration of the watch 1 such as described here, the central region 15 is completely transparent, in other words: free from any visual obstruction of another element of the watch 1 with the exception of the indicator plates 5. Indeed, since the drive unit 6 and the holding means 10 are comprised in the case middle 2, the central region 15 comprises no staff for holding the indicator plates 5, nor movement as is usual in conventional mystery watches. In such a configuration, and inasmuch as the plates 5 are transparent, the indicators 7 for each of the indicator plates 5 are visible from the first face 3, forming a first display, as well as from the second face 4, forming a second display. The mystery watch 1 as described here thus has the advantage of being reversible, i.e. allowing the first and second display to be read depending on whether the first resp. second face 3, 4 of the watch 1 is viewed. In other words, the watch can be worn turned on one of the faces 3, 4 so as to display selectively one or the other of the displays.

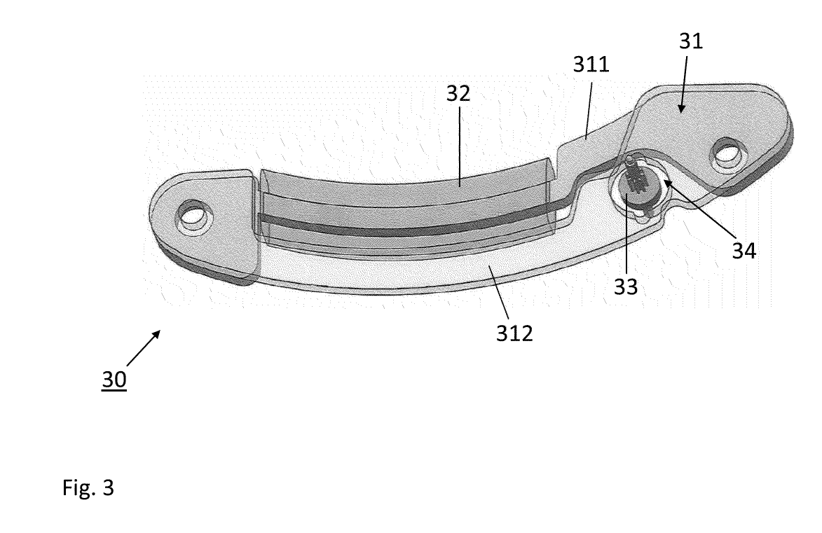

In one embodiment, not represented, the drive unit 6 comprises a quartz oscillator drive, comprising an electric motor, energy source (battery), quartz oscillator, electronic circuit and a gear-train adapted for driving the indicator plates 5, for example, through their peripheral toothing 9. In a preferred manner, the electric motor is a stepping motor of the Lavet type. FIG. 3 illustrates the stepping motor 30 according to one embodiment. The motor 30 comprises a stator 31 having two branches 311, 312: one of the branches 311 bears a winding 32 which, when under voltage, enables a magnetic field to be created in the stator 31. In one advantageous configuration, the stator 31 has roughly the shape of an arc of circle, and an opening 43 and a rotor 33 of the motor 30 are placed in one extremity of the stator 31, in the extension of the arc formed by the stator 31. In a preferred manner, the arc-shaped radius of the stator 31 can correspond roughly to that of the annular case middle 2. In this advantageous configuration, the case middle 2 comprising the motor 30 can have a reduced thickness as compared with that which can be achieved with a conventional motor. Decreasing the intermediate space provided between the branches 311, 312 can further reduce the size of the motor 31. The particular shape in an arc of circle of the stator 31 enables the drive unit 6 to be housed outside of the central region 15, completely in the case middle 2 of the watch 1. This shape of the stator 31 makes possible the configuration of the watch 1 with the case middle 2 in an annular shape and the concentric central region 15 with the case middle 2.

In one embodiment, the central region has a surface corresponding to at least half of the sum of the surface of the case middle 2 and of the surface of the central region 15. Here, the surface of the case middle is defined by the difference between the outer diameter and the inner diameter of the case middle 2. For example, in the example illustrated in FIGS. 1 and 2, the surface of the central region 15 is approximately 55% of the surface occupied by the annular case middle 2. However, there is nothing to prevent the watch 1 to be executed with other proportions between the surface of the case middle 2 and that of the central region 15. Other shapes for the case middle 2 are also possible, for example the case middle 2 can have an ovoid or angular shape. The central region can also be off-centered relative to the case middle 2.

It is evident that the present invention is not limited to the embodiment that has just been described and that various simple modifications and variants can be contemplated by the one skilled in the art without falling outside the scope of the present invention. For example, the watch can comprise more than two indicator plates 5. The additional indicator plate or plates 5 can be used for displaying the seconds or another other functions such as displaying the date, the power reserve, chronometer etc. The indicator plates 5 can have the shape of a disc with a diameter at least as great as the diameter of the central region 15 or a smaller diameter. The indicator plates 5 can also be pivoted in an off-centered fashion at the center of the central region 15.

The watch can comprise markings (not represented) on which the indicators come to point, for determining among others the current time and minute. These markings can be comprised on one element of the first and/or of the second face 3, 4 so as to be visible from the two faces 3, 4, forming the first resp. second display. Such an element will preferably be placed close to the periphery of the central region 15 so as to leave the central region 15 essentially free of any visual obstruction. For example, the watch 1 can comprise a dial with the markings, wherein the dial has an annular shape placed at the periphery of the central region 15. The dial can also have the shape of a transparent disc including the markings. The element and/or markings seen from the first face 3 can be essentially identical to those seen from the second face 4 so as to read the same information on the two faces 3, 4, albeit in a possibly inverted manner. In another variant embodiment, the element and/or markings of the second face 4 are different from those of the first face 3 so that the first display is different from the second display. For example, the element and/or the markings of the first face 3 can be associated with the indicator plates 5 for the hours and minutes, whilst the element and/or markings of the second face 4 can be associated with the indicator plates 5 of the chronometer and/or of the date. It is possible that this latter configuration may render the reading more complex since all the indicators are visible simultaneously from the first face 3 and from the second face 4. However, such a display can amplify the “mysterious” and fanciful aspect of the watch 1. It will be noted that the indicator plates 5 will be seen as turning clockwise or anti-clockwise depending on whether the watch 1 is viewed from face 3 or face 4.

In a variant embodiment, not represented, each of the indicator plates 5 can comprise an optically variable element, i.e. an element that gives the indicator plate 5 a visual aspect that varies according to the viewing angle, depending on whether the plate 5 is viewed from the first or the second face 3, 4, and with the rotation of the plate 5. The optically variable element can include a polarizing element. Such an arrangement makes it possible to create a visual interest that differs depending on the face 3, 4 of the watch that is viewed. This visual character can be reinforced by arranging the markings of the first and second face 3, 4 and of the texture and/or colors of the case middle 2 on the side of the first and second face 3, 4. The optically variable element can also include a motive producing a variegated or moiré effect when one of the plates 5 pivots relative to another of the plates 5.

In yet another embodiment, not represented, one of the faces of each of the indicator plates 5 comprises a first graphical element and the other face of the indicator plate 5 comprises another graphical element distinct from the first graphical element. Such an arrangement makes it possible to achieve a display that differs visually when the watch 1 is viewed from the face 3 or the opposite face 4, a little as though there were two watches in one.

Thanks to its characteristics in terms of structure, conformation and layout of its different elements, the watch described further above in relation to FIGS. 1 and 2 presents a new and original aesthetic aspect that can be summed up by the expression “reversible mystery watch”.

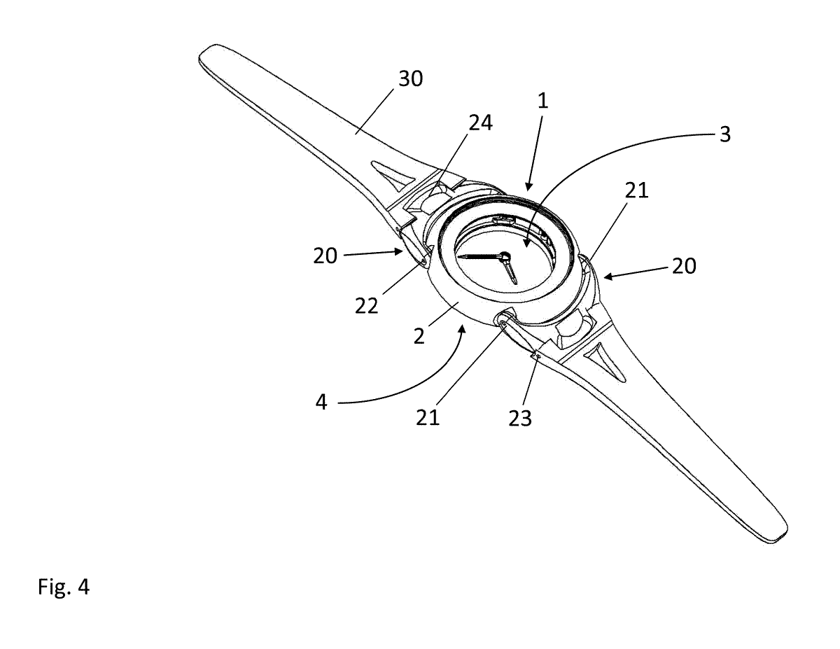

FIG. 4 represents a perspective view of the watch 1 comprising a bracelet 25 and two fastening elements 20 for fastening the bracelet 25 onto the case middle 2 of the watch 1 so that the watch 1 can be worn on a wrist, according to one embodiment. More particularly, each of the fastening elements 20 comprises, at one extremity, first affixing means 21 for attaching the fastening element 20 in a pivoting fashion onto the case middle 2. At the other extremity, each of the fastening elements 20 comprises second affixing means 24 for attaching the bracelet 25 in a pivoting fashion onto the fastening element 20. In the example of FIG. 3, the two fastening elements 20 are placed in an opposite fashion on the case middle 2. The first affixing means comprise a pair of arms 21 fastened in a pivoting fashion onto the case middle 2, for example, by means of pins or screws (not visible in FIG. 3) extending through an opening 22 provided in each arm 21. The second affixing means comprise a fastening bracket 24 onto which the bracelet 25 is fastened in a pivoting fashion by means of a pin 23, extending in a transverse fashion through the extremity of the bracelet 25 and fastening bracket 24. The bracelet 25 can also be attached to the fastening element 20 in a conventional manner, for example by means of a bar (not represented).

The fastening elements 20, affixed in a pivoting fashion relative to the case middle 2, enable the watch 1 to be worn on the wrist with either the first face 3 being on the wrist side or the second face 4 being on the wrist side, whilst ensuring the watch 1 and the bracelet 25 are well adjusted around the wrist. In other words, pivoting the fastening element 20 enables the space between the extremity of the bracelet fastened to the fastening element 20 and the wrist to be minimized. The watch 1 can thus be worn comfortably in both directions.

### REFERENCE NUMBERS USED IN THE FIGURES

1 watch

2 case middle

3 first face

4 second face

5 indicator plate

6 drive unit

7 indicator

8 support

9 peripheral toothing

10 roller

11 stud

12 clamping screw

13 groove

14 periphery

15 central region

100 parts of rollers

200 portion of the case middle

20 fastening element

21 first affixing means, arms

22 bar

23 pin

24 second affixing means, fastening bracket

25 bracelet

30 stepping motor

31 stator

311 branch

312 branch

32 winding

33 rotor

34 opening

1-20. (canceled)

21. Watch comprising:
a watchcase with a case middle forming a transparent central region,
a first display placed on the side of a first face and a second display placed on the side of a second face opposite the first face;
at least two transparent indicator plates placed in a pivoting fashion and superimposed in the central region, wherein each indicator plate comprises at least one indicator;
a drive unit comprising an electric motor, an energy source, a quartz oscillator, an electronic circuit and a gear-train, the drive unit driving each indicator plate in rotation at its periphery by means of the gear-train;
holding means capable of holding each indicator plate at its periphery in a position roughly perpendicular to its rotation axis; such that
the drive unit and the holding means are being housed completely in the case middle of the watch and outside the central region; and that
said at least one indicator of each of the indicator plates is visible on the first face so as to form the first display, and visible on the second face so as to form the second display.

22. Watch according to claim 21, wherein the holding means include rollers comprised in the case middle.

23. Watch according to claim 22, wherein the holding means comprise three rollers spaced angularly from one another by approx. 120°.

24. Watch according to claim 21, wherein the holding means comprise ball bearings.

25. Watch according to claim 21, wherein the central region has a surface corresponding to at least half of the sum of the surface of the case middle and of the surface of the central region.

26. Watch according to claim 21, wherein the case middle has a ring shape and the central region is concentric with the case middle.

27. Watch according to claim 21, wherein each indicator plate has the shape of a disc comprising a peripheral toothing, wherein the toothing meshes with the drive unit so as to drive the indicator plate.

28. Watch according to claim 27, wherein the toothing is formed integrally with each indicator plate.

29. Watch according to claim 21, wherein the indicator plate comprises an optically variable element.

30. Watch according to claim 21, wherein said at least two transparent indicator plates comprise an hours' indicator plate and a minutes' indicator plate.

31. Watch according to claim 30, wherein said at least two transparent indicator plates further comprise an indicator plate for displaying the seconds and/or an indicator plate for displaying the dates and/or an indicator plate for displaying the power reserve.

32. Watch according to claim 21, wherein the first display and the second display comprise markings.

33. Watch according to claim 32, wherein the markings are comprised on an element of the first and/or of the second display, wherein the element is close to the periphery of the central region.

34. Watch according to claim 21, wherein one of the faces of each of the indicator plates comprises a first graphical element and the other face of the indicator plate comprises another graphical element distinct from the first graphical element.

35. Watch according to claim 21, wherein the indicators can be executed with the plate in a same injection mold.

36. Watch according to claim 21, wherein the indicators can be executed by over-molding during the plastic injection of the plate, making it possible to manufacture the plate and the indicator of different materials.

37. Watch according to claim 21, further comprising a bracelet and two fastening elements for fastening the bracelet onto the case middle so that the watch can be worn on a wrist, wherein each of the fastening elements comprises, at one extremity, first affixing means for attaching the fastening element in a pivoting fashion onto the case middle, and, at the other extremity, second affixing means for attaching the bracelet in a pivoting fashion onto the fastening element, so that the case middle and the bracelet adjust to the wrist when the watch is worn.

38. Watch according to claim 21, wherein the drive unit includes a stepping motor of the Lavet type.

39. Watch according to claim 38, wherein the motor comprises a stator having roughly the shape of an arc of circle and a rotor comprised at one extremity of the stator, in the extension of the arc formed by the stator.
